(19) United States
(12) Patent Application Publication
(10) Pub. No.: US 2026/0138202 A1
(43) Pub. Date: May 21, 2026

(54) WELDING PROCESS AUTOMATION

(71) Applicant: TECNAR AUTOMATION LTEE, Saint-Bruno-de-Montarville (CA)

(72) Inventors: Alexandre Nadeau, Saint-Bruno-de-Montarville (CA); Christian Trudel, Saint-Bruno-de-Montarville (CA); Philippe Fontaine, Saint-Bruno-de-Montarville (CA); Vincent Carbonneau, Saint-Bruno-de-Montarville (CA); Pierre Parent, Saint-Bruno-de-Montarville (CA); Martin Ferguson, Saint-Bruno-de-Montarville (CA)

(73) Assignee: TECNAR AUTOMATION LTEE, Saint-Bruno-de-Montarville, (CA)

(21) Appl. No.: 19/178,830

(22) Filed: Apr. 14, 2025

Related U.S. Application Data
(60) Provisional application No. 63/646,018, filed on May 13, 2024.

(51) Int. Cl. B23K 9/095; B23K 9/028; B23K 9/12; B23K 9/133

(52) U.S. Cl. CPC B23K 9/0956; B23K 9/028; B23K 9/126; B23K 9/133

(57) ABSTRACT

Methods and devices for automating operation of a welding system are provided. A camera configured for acquiring images in real time of a welding zone comprising a bevel joint is provided. A processor is operatively connected to the welding system and in communication with the camera to receive the images in real time. For each image acquired by the camera, an instant arc position of a welding arc in the bevel joint. The processor then determines an optimal arc position of the welding arc in the bevel joint, and an error between the instant arc position and the optimal arc position. A correction to operating parameters of the welding system to align the instant arc position with the optimal arc position is calculated, and control signals are sent to the welding system to apply the correction to the operating parameters.

### TECHNICAL FIELD

The technical field generally relates to automated welding.

### BACKGROUND

Industrial welding of metal workpieces, for example pipe segments to be connected together seamlessly, require skill and precision. Experienced pipe welders are however hard to find, and fabricators look for ways to increase their productivity while delivering high-quality products. Reducing production delays and costs are also concerns.

While robotic welding systems have allowed improvements in productivity and production conditions, they still require highly skilled operators.

There remains a need for an automation device and method for welding systems that alleviates at least some of the drawbacks of prior art.

### SUMMARY

In accordance with one aspect, there is provided an automation device for automating operation of a welding system for providing a weld at a bevel joint between two metal workpieces, the welding system comprising a welding torch generating a welding arc and a welding wire being fed from the welding torch to the bevel joint to form a weld pool at the bevel joint, the automation device comprising:
a camera configured for acquiring images in real time of a welding zone comprising the bevel joint;
a processor operatively connected to the welding system and in communication with the camera to receive the images in real time, the processor configured to, for each image acquired by the camera:
   a. determine an instant arc position of the welding arc in the bevel joint;
   b. determine an optimal arc position of the welding arc in the bevel joint;
   c. determine an error between the instant arc position and the optimal arc position;
   d. calculate a correction to operating parameters of the welding system to align the instant arc position with the optimal arc position; and
   e. send control signals to the welding system to apply said correction to the operating parameters thereof.

In some implementations, the camera comprises a CCD or a CMOS sensor.

In some implementations, the camera is sensitive to infrared radiation.

In some implementations, the camera is positioned in front of the weld pool at a right angle with a longitudinal axis of the workpieces.

In some implementations, the camera comprises a protective lens.

In some implementations, the automation device comprises an image processing software performing the processing of each of said images.

In some implementations, the image processing software is configured to identify, in said images, extremities of metal workpieces at the bevel joint, the weld pool and the welding arc.

In some implementations, the image processing software is configured to determine a contour of the weld pool and/or a contour of the welding arc based on a shade contrast in said images.

In some implementations, the image processing software is configured to determine at least one of a shape of the welding arc, a position of a center of the welding arc and a length of the welding arc.

In some implementations, the two workpieces are separated by a gap, and the image processing software is configured to determine at least one of a width of the gap, a shape of the gap, and positions of a bottom left corner and a bottom right corner of the gap.

In some implementations, the image processing software is configured to determine a width of the weld pool.

In some implementations, the image processing software is configured to determine a distance between a bottom edge of the welding torch and a center of the welding arc.

In some implementations, the image processing software is configured to determine a stick-out distance of the welding wire.

In some implementations, the image processing software is configured to determine a relative leading front edge of the welding arc with respect to a front end of the welding pool.

In some implementations, the image processing software is configured to determine a mismatch in height between the two metal workpieces.

In some implementations, the image processing software is configured to determine:
an instant center of the welding arc;
a left corner of a bottom of the bevel joint;
a right corner of the bottom of the bevel joint;
a center of the bottom of the bevel joint;
a left corner where a left side of the bevel joint changes from going upwardly to go oblique and outwardly;
a right corner where a right side of the bevel joint changes from going upwardly to go oblique and outwardly; and
a contour of the bevel joint.

In some implementations, the instant arc position of the welding arc in the bevel joint determined by the processor is a position of a center of the welding arc relative to the weld pool.

In some implementations, the optical arc position is set in front the weld pool and aligned with a center of the weld pool.

In some implementations, the processor determines the optimal arc position based on a shape and dimensions of the bevel joint, the instant arc position and a position of the weld pool.

In some implementations, the optimal arc position is set to a next position of the welding arc along a predetermined ideal arc path.

In some implementations, the error between the instant arc position and the optimal arc position is set as a distance therebetween.

In some implementations, the operating parameters of the welding system comprise a moving speed of the workpieces.

In some implementations, the operating parameters of the welding system comprise a relative speed of movement between the welding torch and the workpieces.

In some implementations, the operating parameters of the welding system comprise an arc power of the welding arc.

In some implementations, the operating parameters of the welding system comprise a position of the welding torch.

In some implementations, the operating parameters of the welding system comprise a predetermined arc path of the welding arc.

In some implementations, the operating parameters of the welding system comprise a stick-out distance of the welding wire.

In some implementations, the operating parameters of the welding system comprise a feeding speed of welding wire.

In some implementations, the operating parameters of the welding system comprise:
a moving speed of the workpieces;
an arc power of the welding arc;
a position of the welding torch;
a predetermined arc path of the welding arc;
a stick-out distance of the welding wire; and
a feeding speed of welding wire.

In accordance with another aspect, there is provided an automation device as above, in combination with said welding system.

In some implementations, the welding system comprises a welding arm configured to support and move the welding torch, the camera of the automation device being mounted on said welding arm below the welding torch.

In some implementations, the welding system comprises one or more additional welding torches each operatively coupled to the automation device.

In some implementations, the welding system comprises a controller operatively connected to the welding torch, the controller comprising said processor.

In accordance with another aspect, there is provided an automation method for automating operation of a welding system for providing a weld at a bevel joint between two metal workpieces, the welding system comprising a welding torch generating a welding arc and a welding wire being fed from the welding torch to the bevel joint to form a weld pool at the bevel joint, the automation method comprising:
a) acquiring, using a camera, images in real time of a welding zone comprising the bevel joint; and
   via a processor operatively connected to the welding system and in communication with the camera to receive the images in real time, performing the step of:
b) processing each of the images to:
   i. determine an instant arc position of the welding arc in the bevel joint;
   ii. determine an error between the instant arc position and an optimal arc position; and
   iii. calculate a correction to operating parameters of the welding system to align the instant arc position with the optimal arc position; and
c) sending control signals to the welding system to apply said correction to the operating parameters thereof.

In some implementations, the metal workpieces are pipe sections.

In some implementations, the automation method comprises pre-assembling and holding together by temporary fasteners the workpieces with contiguous edges thereof forming the bevel joint.

In some implementations, the automation method further comprises moving the workpieces relative to the welding torch.

In some implementations, the automation method comprises performing steps a) to c) over a root welding pass.

In some implementations, the automation method comprises performing steps a) to c) over a one or more filling welding passes.

In some implementations, the automation method comprises performing steps a) to c) over a capping welding pass.

In some implementations, the automation method comprises a start-up phase comprising performing the processing of step b) on a first set of said images without applying the corresponding correction to the operating parameters.

Other features and advantages will be better understood upon of reading of detailed embodiments with reference to the appended drawings.

### BRIEF DESCRIPTION OF THE DRAWINGS

FIG. 1 is a schematized representation of a welding system including an automation device according to one embodiment; FIG. 1A is an enlarged view of area A of FIG. 1.

FIG. 2A is a side elevation view of a welding system including an automation device according to one embodiment; FIG. 2B is a front view of the welding area of the welding system of FIG. 2A.

FIG. 3 is a flow chart of a portion of an automation method for automating operation of a welding system according to one embodiment.

FIGS. 4A to 4C are examples of images acquired by au automation device according to one embodiment for a root pass (FIG. 4A) and for a filling pass (FIGS. 4B and 4C).

FIGS. 5A to 5C illustrate the image capture and processing steps according to one example of implementation; FIG. 5A schematically represents the real object in the field of view of the camera, including two workpieces; FIG. 5B schematically represents the unprocessed image acquired by the camera; and FIG. 5C schematically represents the contours of the weld pool and of the welding arc determined by the image processing software based on the image of FIG. 5B.

FIGS. 6A and 6B schematically illustrate different parameters which may be calculated, respectively in the context of a root pass (FIG. 6A) and a filling pass (FIG. 6B).

FIG. 7 is a schematized representation of a case during a root pass where the instant center of the welding arc coincides with the optical arc position; FIG. 7A is a schematized representation of a case where the instant center of the welding arc is too low compared to the optimal arc position; and FIG. 7B is a schematized representation of a case where the instant center of the welding arc is too high.

FIG. 8 is a schematized representation of a case during a filling pass the weld pool 24 may oscillate from left to right; FIG. 8A is a schematized representation of a case where the workpiece speed is too slow; and FIG. 8B is a schematized representation of a case where the arc power is too high.

FIG. 9 is a schematized representation of the measuring of a hi-lo.

### DETAILED DESCRIPTION

In the present description, similar features in the drawings have been given similar reference numerals. To avoid cluttering certain figures, some elements may not be indicated if they were already identified in a preceding figure. It should also be understood that the elements of the drawings are not necessarily depicted to scale, since emphasis is placed on clearly illustrating the elements and structures of the present embodiments. Positional descriptors indicating the location and/or orientation of one element with respect to another element are used herein for ease and clarity of description. Unless otherwise indicated, these positional descriptors should be taken in the context of the figures and should not be considered limiting. It is appreciated that such spatially relative terms are intended to encompass different orientations in the use or operation of the present embodiments, in addition to the orientations exemplified in the figures. Furthermore, when a first element is referred to as being “on”, “above”, “below”, “over”, or “under” a second element, the first element can be either directly or indirectly on, above, below, over, or under the second element, respectively, such that one or multiple intervening elements may be disposed between the first element and the second element.

The terms “a”, “an”, and “one” are defined herein to mean “at least one”, that is, these terms do not exclude a plural number of elements, unless stated otherwise. The term “or” is defined herein to mean “and/or”, unless stated otherwise.

The expressions “at least one of A, B, and C” and “one or more of A, B, and C”, and variants thereof, are understood to include A alone, B alone, and C alone, as well as any combination of A, B, and C.

Terms such as “substantially”, “generally”, and “about”, which modify a value, condition, or characteristic of a feature of an exemplary embodiment, should be understood to mean that the value, condition, or characteristic is defined within tolerances that are acceptable for the proper operation of this exemplary embodiment for its intended application or that fall within an acceptable range of experimental error. In particular, the term “about” generally refers to a range of numbers that one skilled in the art would consider equivalent to the stated value (e.g., having the same or an equivalent function or result). In some instances, the term “about” means a variation of ±10% of the stated value. It is noted that all numeric values used herein are assumed to be modified by the term “about”, unless stated otherwise. The term “between” as used herein to refer to a range of numbers or values defined by endpoints is intended to include both endpoints, unless stated otherwise.

The term “based on” as used herein is intended to mean “based at least in part on”, whether directly or indirectly, and to encompass both “based solely on” and “based partly on”. In particular, the term “based on” may also be understood as meaning “depending on”, “representative of”, “indicative of”, “associated with”, and the like.

The terms “match”, “matching”, and “matched” refer herein to a condition in which two elements are either the same or within some specified tolerance of each other. That is, these terms are meant to encompass not only “exactly” or “identically” matching the two elements but also “substantially”, “approximately”, or “subjectively” matching the two elements, as well as providing a higher or best match among a plurality of matching possibilities.

The terms “connected” and “coupled”, and derivatives and variants thereof, refer herein to any connection or coupling, either direct or indirect, between two or more elements, unless stated otherwise. For example, the connection or coupling between elements may be mechanical, optical, electrical, magnetic, thermal, chemical, logical, fluidic, operational, or any combination thereof.

The term “concurrently” refers herein to two or more processes that occur during coincident or overlapping time periods. The term “concurrently” does not necessarily imply complete synchronicity and encompasses various scenarios including time-coincident or simultaneous occurrence of two processes; occurrence of a first process that both begins and ends during the duration of a second process; and occurrence of a first process that begins during the duration of a second process, but ends after the completion of the second process.

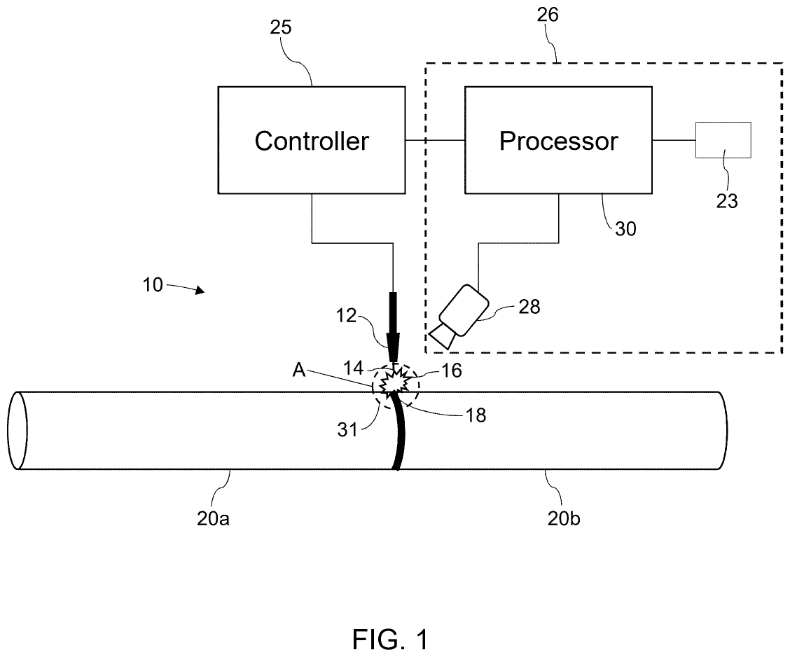

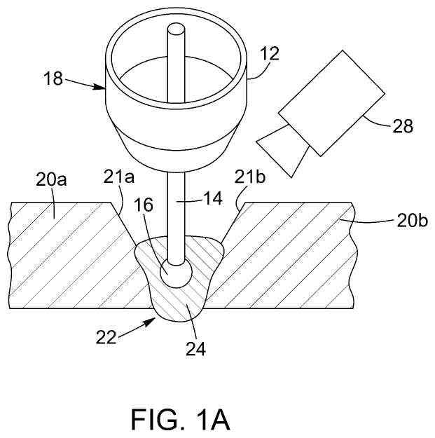

Referring to FIGS. 1 and 1A, in accordance with some aspects, there is provided an automation device 26 for automating operation of a welding system 10.

The automation device 26 described herein may be used in the context of any welding system 10 apt to create a weld 18 between two or more metal workpieces 20a, 20b. The metal workpieces 20a, 20b may be made of carbon steel, stainless steel and alloy steel, or the like. In typical embodiments (such as shown in FIG. 1), the workpieces 20a, 20b are pipe sections united by the weld 18 so as to be seamlessly joined together into a pipe assembly. It will however be readily understood that the automation device 26 described herein may be used in the context of welding together workpieces having different shapes, such as extrusions, metal sheets or any other shape. Typically, the workpieces are pre-assembled and held together by temporary fasteners with their contiguous edges forming a joint having a bevel shape and referred to as a bevel joint 22.

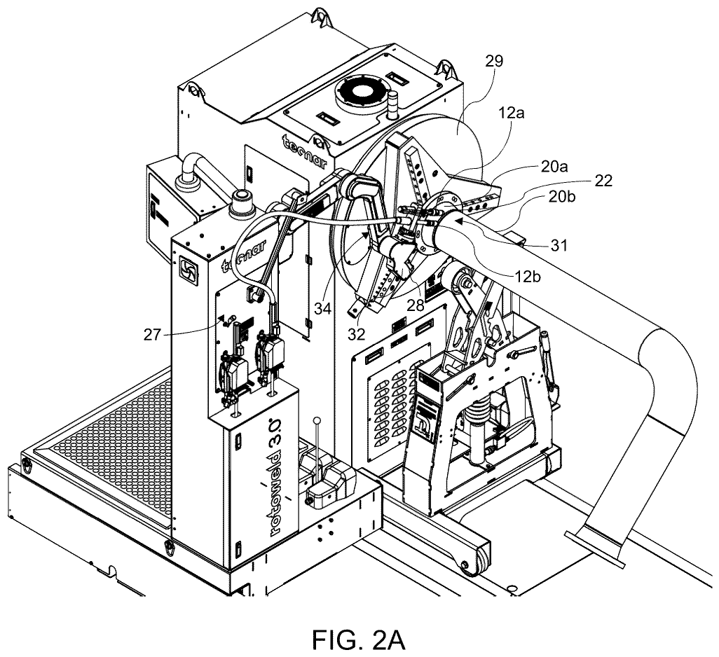

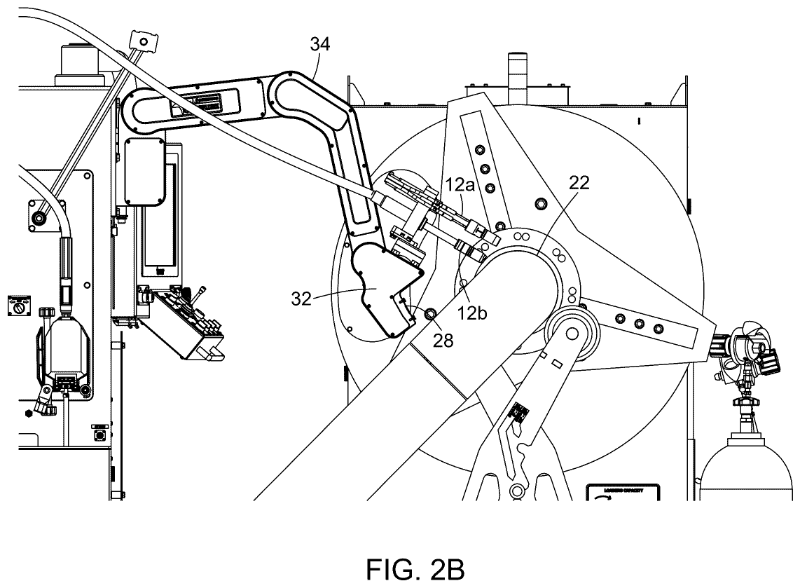

Referring to FIGS. 1, 1A, 2A and 2B, there is shown an example of a welding system 10. The illustrated welding system 10 includes one or more welding torches 12 and a welding wire 14. In operation, the welding torch 12 generated a welding arc 16 to perform electric arc welding, such as for example gas metal arc welding (GMAW) metal insert gas (MIG), submerged arc welding (SAW), flux-cored arc welding (FCAW), metal-cored arc welding (MCAW), gas tungsten arc welding (GTAW) or any other type of arc welding. some embodiments, the welding torch 12 may be positioned at an angle from the normal direction of the workpieces to be welded together. It will be readily understood that although a single or two welding torches are referenced in the description below, in some implementations the welding system may include any number welding torches without departing from the scope of protection. For example, in the example of FIGS. 2A and 2B, a first welding torch 12b may be used to perform a first pass of welding and a second welding torch 12a to perform a filling pass of the weld. The two torches 12a, 12b may operate with different types of electric arc welding methods.

As mentioned above, the welding system 10 also includes a welding wire 14 which is fed to the welding torch 12, as well known in the art. The choice of material of the welding wire 14 may vary depending on the type of electric arc welding that is used. Typically, the first and second welding torches 12a and 12b are provided at their welding end with a gas cup (not shown) from which is discharged a stream of inert gas and from which the welding wire 14 is continuously fed to the bevel joint 22 to form a weldpool 24 penetrating the bevel joint 22.

Electric arc welding is a type of welding that requires, as its name suggests, an electric arc. In practice, the metal workpieces 20a, 20b are charged positively or negatively, and an electrode of the welding torch is charged with the opposite polarity. Referring to FIG. 1A, as the welding torch 12 is moved close to the bevel joint 22 between the metal workpieces 20a and 20b, an electric arc is formed, generating heat. This heat melts the welding wire 14 and the adjacent surfaces 21a, 21b of the metal workpieces 20a, 20b, creating the weld pool 24. It is understood that the weld pool 24 can also be called a puddle by a person skilled in the art. The welding arc 16 is maintained in front of the weld pool 24. As the welding of the workpieces 20a, 20b progresses, the weld pool 24 cools down under the protective cover created by gases from the welding torch 12 and creates the weld.

Referring to FIGS. 2A and 2B, the welding system 10 includes a welding arm 34 configured to support and move the one or more welding torches 12. The welding system may further include a support structure 27 on which the welding arm 34 is mounted. The welding arm 34 may be articulated and automated to rotate and/or translate according to multiple axes, such that the welding torches 12a and 12b may be moved as required with respect to the workpieces 20a, 20b. In embodiments wherein the workpieces 20a, 20b are pipe sections forming a pipe assembly, a rotating mechanism 29 may be provided so as to rotate the pipe assembly according to its central longitudinal axis, thereby moving the workpieces 20a, 20b relative to the welding torch 12 to create a weld along the entire circumference of the pipes.

Typically, three different types of passes are used to completely weld together two pipe sections. The first pass is generally referred to as the root pass and is often considered the most complex pass to execute. As is known in the art of welding, a good penetration of the weld pool 24 is dependent on several parameters, such as the proper centering of the welding torch 12 in the bevel joint 22, ensuring that the hottest metal is directed towards the bottom of the weld pool 24, and the control of welding parameters (i.e. heat and mass balance), which will be explained in more details below. The next pass or passes are typically referred to as filling passes. Typically, multiple filling passes are required to fill the bevel joint 22. Usually, in order to create a good weld 18, the welding torch 12 oscillates side-to side over the bevel joint 22 to melt enough metal from the workpieces 20a, 20b. Finally, the last type of pass is referred to as a capping pass. The capping pass generally ensures a smooth finish of the weld 18 across the outer surface of the pipe or other assembly of workpieces. Of course, the present method may be used in different contexts, such as for example filet welding.

The welding process and the quality of the resulting weld are impacted by several operating parameters of the welding system 10. These operating parameters may include:
Torch position: The position of the welding torch 12 relative to the workpieces 20a, 20b has an impact the amount of heat generated in the weld pool 24 and the position of this weld pool 24 within the bevel joint 22;
Welding wire feeding speed: The feeding speed of the welding wire 14 correlates to the quantity of molten metal inside the weld pool 24 has an impact on the quality of the weld 18;
Travel speed, that is, the torch feed speed in the direction of the joint. This may include the speed at which the pipes are rotated or otherwise moved with respect to the welding arc, which may have an impact on the quantity of molten metal inside the weld pool 24 and the cooling down. This speed can represent the speed at which the pipes rotated with respect to the welding torch or the speed at which the welding torch turns around the bevel joint of the working pieces;
Arc power: The quantity of electrical power used to generate the arc has directly an impact on the temperature inside the weld pool 24. As is known in the arc, several aspects of the arc power may be controlled, such as the back-group current, pinch current, tail-out current, and the like. In some embodiments the arc power may be continuous, whereas in other variants the arc power may be pulsed.
Weaving width, i.e. the left and right oscillation of the weld pool 24 within the gap.

Referring back to FIG. 1, a controller 25 may be provided to control the operating parameters of the welding system 10. The controller can be implemented in hardware, software, firmware, or any combination thereof, and be connected to various components of the welding system 10 via wired and/or wireless communication links to send and/or receive various types of signals, such as timing and control signals, The controller may be controlled by direct user input and/or by programmed instructions, and may include an operating system for controlling and managing various functions of the welding system 10. Depending on the application, the controller 25 may be fully or partly integrated with, or physically separate from, the other hardware components of the welding system.

As mentioned above, the present description provides an automation device 26 for automating operation of a welding system 10 such as the one described above.

With reference to FIGS. 1, 2 and 2A, the automation device 26 includes a camera 28 configured for acquiring images, in real time, of a welding zone 31 which includes the bevel joint 22. The camera 28 therefore acquires images of the welding zone in the bevel joint 22. The images show the bevel joint 22, the weld pool 24 and the welding arc 16.

The camera 28 may for example positioned in front of the weld pool 24 at a right angle with a longitudinal axis of the workpieces, that is, at approximately 70 to 90 degrees. In the illustrated embodiment, the camera 28 is mounted on an end-effector 32 of the welding arm 34, below the welding torch 12b. In some implementations. the camera 28 may be provided with a protective lens to protect it from sparks, splatters or other debris from the welding process. The protective lens may be placed at approximately 45 degrees from the camera 28 to reduce the chances of obstruction of the field of view with welding debris. The camera 28 may be embodied by a CCD or CMOS sensor, or any surface that is sensitive and converts light intensity or energy into a useful signal. In some implementations, the camera may be an infrared camera or may be sensitive to radiation within any suitable wavelength range.

Referring back to FIG. 1, the automation device 26 further includes a processor 30 operatively connected to the welding system 10 and in communication with the camera 28. The processor may be configured to perform any of the analyses and computations described above. A memory 23 may be provided as part of the processor or connected thereto.

The processor 30 may be able to execute computer programs, also generally known as commands, instructions, functions, processes, software codes, executables, applications, and the like. It should be noted that although the processor 30 in FIG. 1 is depicted as a single entity for illustrative purposes, the term “processor” should not be construed as being limited to a single processor, and accordingly, any known processor architecture may be used. In some implementations, the processor 30 may include a plurality of processing units. Such processing units may be physically located within the same device, or the processor 30 may represent processing functionality of a plurality of devices operating in coordination. For example, the controller 25 may include a main processor configured to provide overall control and one or more secondary processors configured for dedicated control operations or signal processing functions. Depending on the application, the processor 30 may include or be part of a computer; a microprocessor; a microcontroller; a coprocessor; a central processing unit (CPU); an image signal processor (ISP); a digital signal processor (DSP) running on a system on a chip (SoC); a single-board computer (SBC); a dedicated graphics processing unit (GPU); a special-purpose programmable logic device embodied in hardware device, for example, a field-programmable gate array (FPGA) or an application-specific integrated circuit (ASIC); a digital processor; an analog processor; a digital circuit designed to process information; an analog circuit designed to process information; a state machine; and/or other mechanisms configured to electronically process information and to operate collectively as a processor. In one embodiment the processor 30 runs at 20 Hz but could used any other frequency.

In some implementations, the processor 30 may be used to implement neural network(s) using computer hardware elements, computer software elements or a combination thereof. Accordingly, the neural networks can be referred to as being computer-implemented. Various computationally intensive tasks of the neural network can be carried out on one or more central processing units and/or graphical processing units of one or more programmable computers. For example, and without limitation, the programmable computer may be a programmable logic unit, a mainframe computer, server, personal computer, cloud-based program or system, laptop, personal data assistant, cellular telephone, smartphone, wearable device, tablet device, virtual reality device, smart display devices such as a smart TV, set-top box, video game console, or portable video game device, among others.

The memory 23, which can also be referred to as a computer readable storage medium, is capable of storing computer programs and other data to be retrieved by the processor 30. The terms “computer readable storage medium” and “computer readable memory” are intended to refer herein to a non-transitory and tangible computer product that can store and communicate executable instructions for the implementation of various steps of the methods disclosed herein. The computer readable memory can be any computer data storage device or assembly of such devices, including random-access memories (RAMs); dynamic RAMs; read-only memories (ROMs); magnetic storage devices, such as hard disk drives, solid state drives, floppy disks, and magnetic tapes; optical storage devices, such as compact discs (e.g., CDs and CDROMs), digital video discs (DVDs), and Blu-RayTM discs; flash drive memories; and/or other non-transitory memory technologies. A plurality of such storage devices may be provided, as can be appreciated by those skilled in the art. The computer readable memory may be associated with, coupled to, or included in a computer or processor configured to execute instructions contained in a computer program stored in the computer readable memory and relating to various functions associated with the computer or processor.

The welding system 10 may also include one or more user interface devices operatively connected to the controller 25 to allow the input of commands and queries to the welding system 10, as well as present the outcomes of the commands and queries. The user interface devices can include input devices (e.g., a touch screen, a keypad, a keyboard, a mouse, a switch, and the like) and output devices (e.g., a display screen, a printer, visual and audible indicators and alerts, and the like).

The processor 30 may be in wired or wireless communication with the camera 28 and receives the images from the camera 28 in real time. It is configured to perform an automation routine to operate the welding system 10.

Referring to FIG. 3, a flow chart of an automation routine 100 according to one embodiment is shown.

The processor 30 first receives 102 each image from the camera in real time, and then processes 104 each image.

In some implementations, at the beginning of the process the processor 30 may first receive 102 and process 104 a first set of a few images before being able to calculate 110 the correction to the operating parameters. Therefore, the method may involve a preliminary start-up phase in which the first few instant arc positions are not corrected.

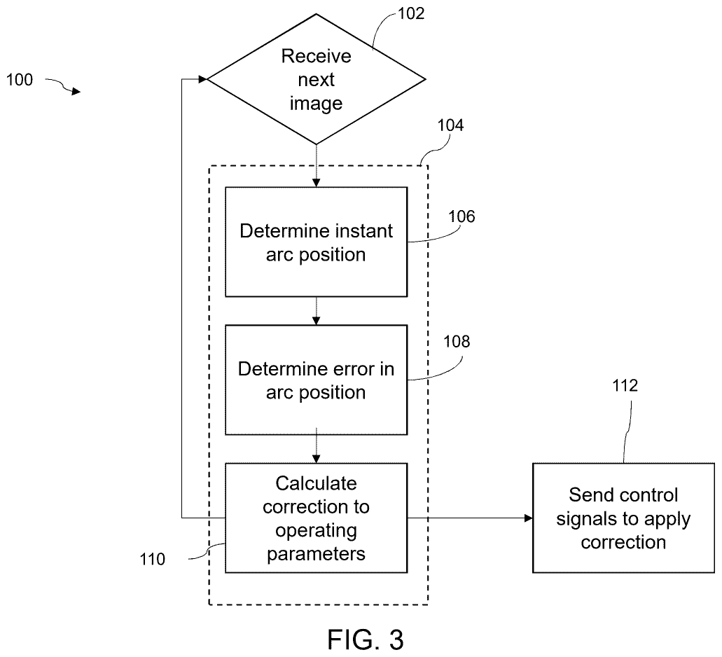

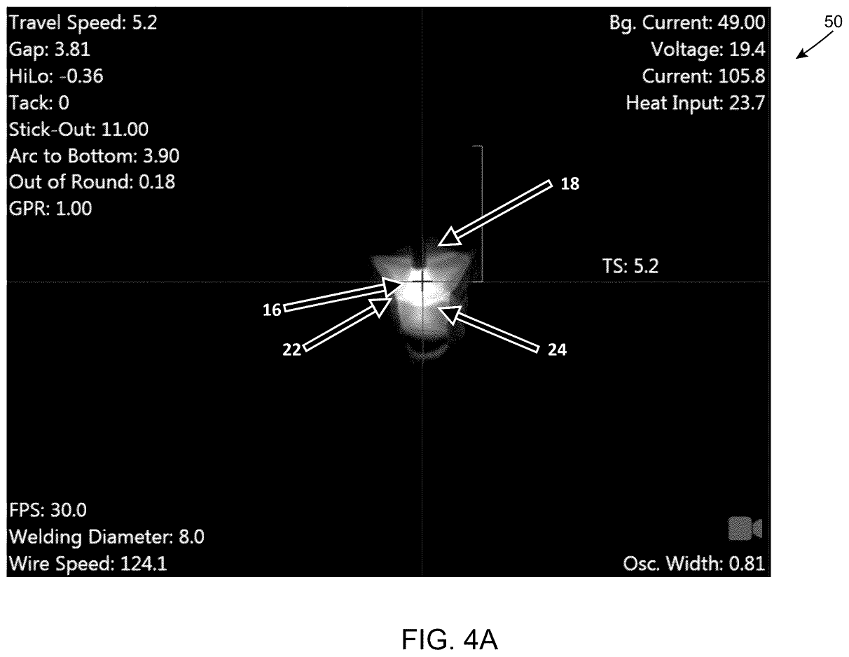

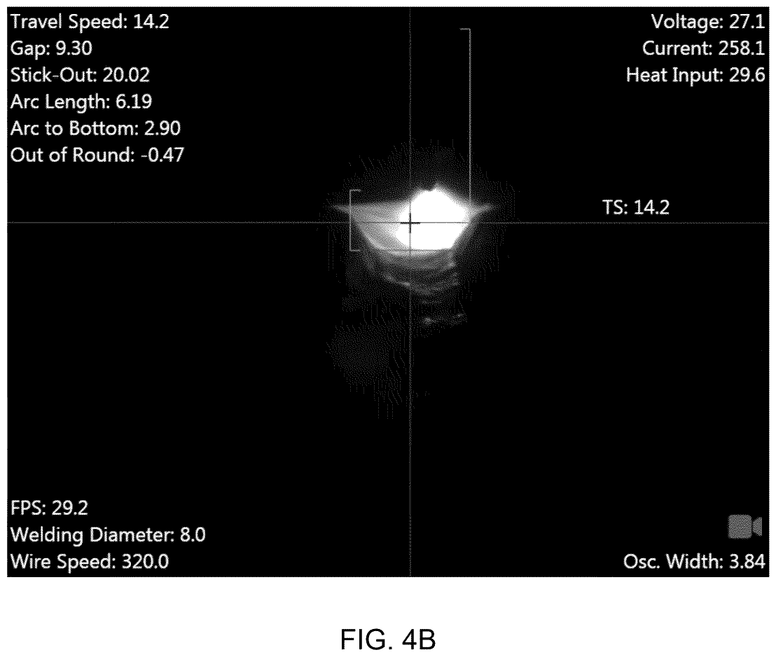

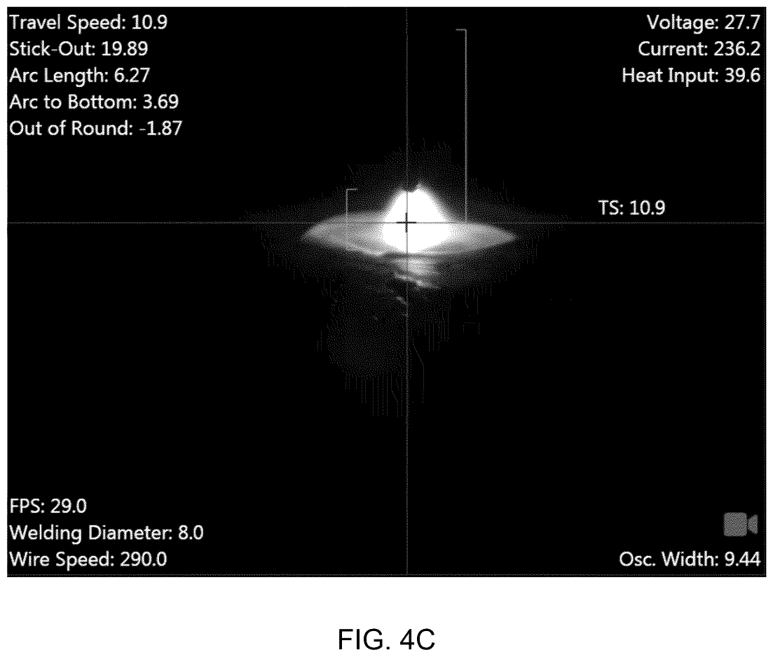

Examples of images as acquired are shown in FIG. 4A for a root pass, and 4B and 4C for a filling pass. In some implementations, an image processing software is used to analyse each image from the camera. The image processing software may be tailored to the welding process and may be configured to detect and identify specific components such as the extremities of the workpieces forming the bevel joint, the weld pool, the welding arc and other features the arc welding process.

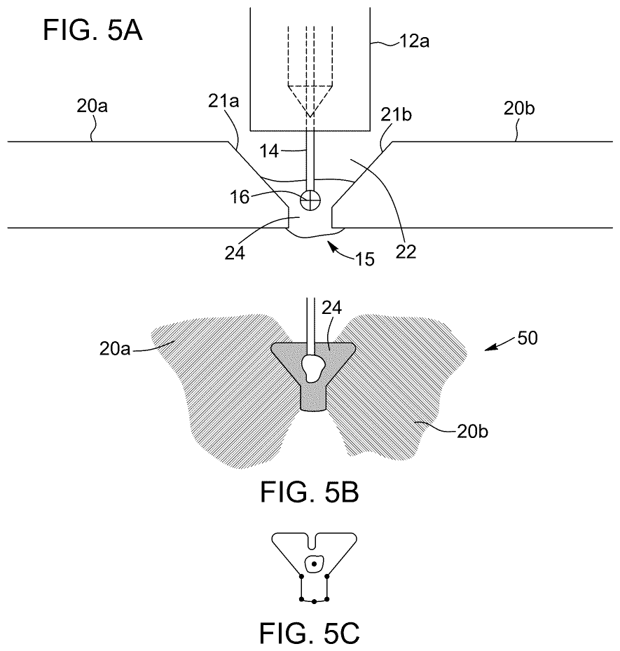

Referring to FIGS. 5A to 5C, the image capture and processing steps according to one example of implementation are shown. FIG. 5A schematically illustrates the real object in the field of view of the camera, including two workpieces 20 and 20b, here embodied by pipes having adjacent side surfaces 21a, 21b forming a bevel joint 22 and in the process of being joined together. A welding torch 12 is in the process of making a root pass, the melting of the welding wire 14 creating a weld pool 24 at the bottom of the gap 15 between the two workpieces. The welding arc 16 can also be seen in front of the weld pool 24. FIG. 5B is a schematic representation of the unprocessed image 50 acquired by the camera. On the image, the workpieces 20a, 20b appear very dark, while the weld pool 24 appears lighter and the welding arc is saturated white (also refer back to FIGS. 4A to 4C). The image processing software is preferably configured to use the shade contrast and/other aspect of the weld pool 24 and welding arc 16 to calculate the contour of both, as illustrated in FIG. 5C.

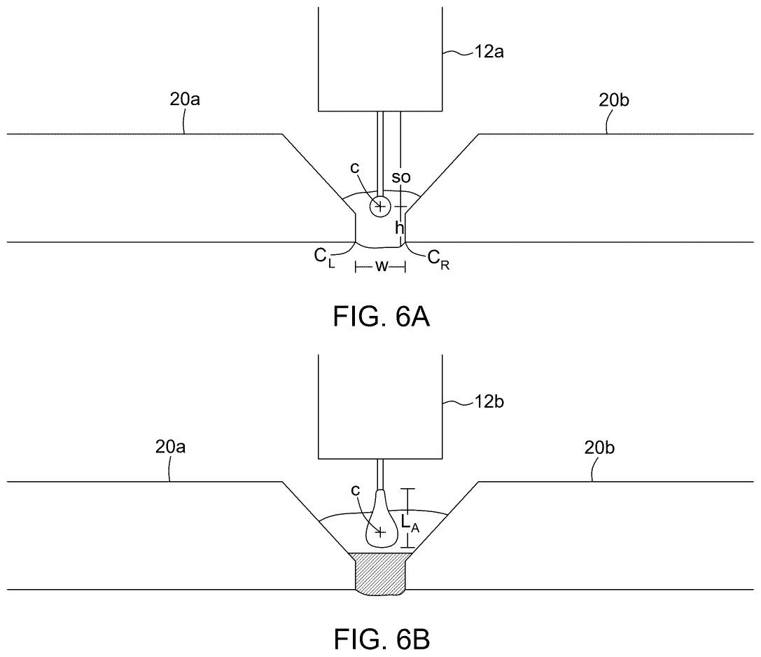

In some implementations, the image processing software is configured to measure geometrical parameters of the features of the acquired images. FIGS. 6A and 6B schematically illustrate different parameters which may be calculated, respectively in the context of a root pass (FIG. 6A) and a filling pass (FIG. 6B). These parameters include:
Arc parameters: the shape of the arc, the position of the center C of the welding arc 15 and the length LA of the welding arc 16;
Gap parameters: The width W and/or shape of the gap between the two workpieces 20a, 20b, and/or the positions of the bottom left and bottom right corners of the gap CL and CR;
Weld pool parameters, such as the width, height and centering of the pass;
The distance SO between the bottom edge of the welding torch 12 and the center C of the welding arc 16, commonly referred to as the stick-out (of the wielding wire);
The relative leading front edge of the arc with respect to the front end of the liquid puddle;
The mismatch in height between the two pipes lined up for welding, commonly referred to as the Hi-Lo or misalignment.

Referring back to the example image of FIG. 4A, the workpieces 20a and 20b are represented in dark grey. The weld pool 24 is in pale grey and the instant arc position 38 is in white, saturating the pixels of the camera. The cross represents the instant center of the welding arc 40, with a horizontal line showing the height from the bottom of the bevel joint 22 and a vertical line showing the oscillation from the sides of the bevel joint. The bracket on the right showing a distance from the instant center of the welding arc 40 to an unknown position higher represents the stick-out, which is understood in the art as the distance between the instant center of the welding arc 40 where the welding wire melts into the weld pool and the welding torch 12. The main features that are detected on the images are 7 points:
the instant center of the welding arc 40;
the left corner of the bottom of the bevel joint;
the right corner of the bottom of the bevel joint;
the center of the bottom of the melt puddle.
the left corner where the left side of the bevel joint changes from going upwardly to go oblique and outwardly;
the right corner where the right side of the bevel joint changes from going upwardly to go oblique and outwardly; and
the contour of the bevel joint 22.

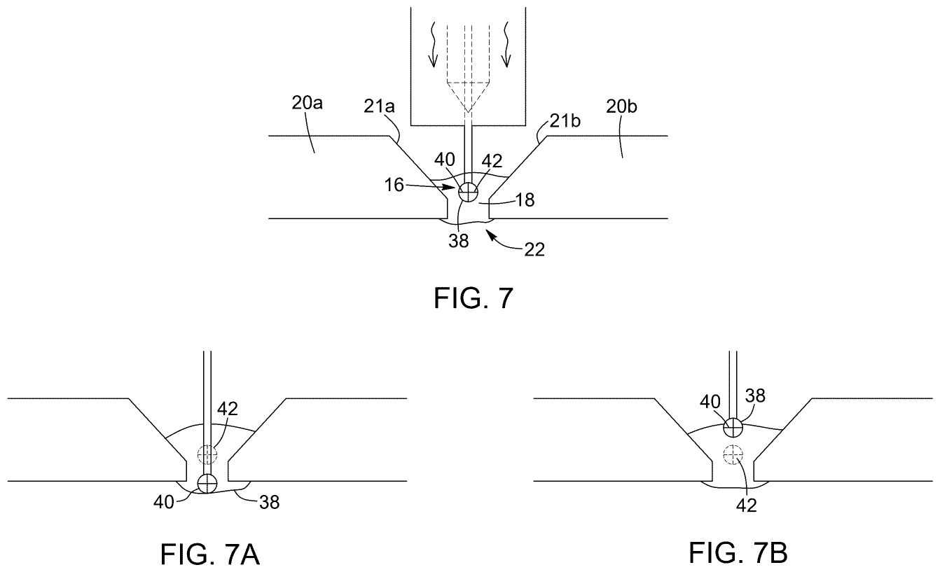

Referring back to FIG. 3 and with additional reference to FIG. 7, the processing of each image first includes determining 106 an instant arc position 38 of the welding arc 16 in the bevel joint 22. In some implementations, the instant arc position 38 is determined as the position of the center C of the welding arc relative to the weld pool.

The processing 104 of the image next includes determining 108 an error between the instant arc position 38 and an optimal arc position 42.

As one skilled in the art would readily understand, the optimal arc position 42 may depend on the shape and the dimensions of the bevel joint 22, the instant arc position 38 and the position of the weld pool 24. In some implementations, the optimal arc position 42 may be defined as the optimal position of the welding arc to ensure a proper filling in the bevel joint 22. In some implementations, the optimal arc position 42 may be a next position of the welding arc 16 along a predetermined ideal arc path. In some instances, the optimal arc position 42 may also involve the length of the welding arc and other associated parameters. By way of example, the optimal arc position may be selected to ensure a proper fusion, a good penetration (on the root pass) and/or an optimized bead shape of the arc.

The error between the instant arc position 38 and the optimal arc position 42 may be defined as the distance between the two points.

In some embodiments, the error may result from a misplacement of the welding arc 16 or from changes in the characteristics of the metal workpieces 20a, 20b or their environment. Examples of such characteristics may include:
the gap between the two sides of the bevel joint,
the difference in height in the bevel joint between the instant arc position 40 and the optimal arc position 42;
a presence of a tack that connected the two metal workpieces 20a, 20b together before the welding process starts,
the stick-out, which is understood in the art as the distance between the instant center of the welding arc 40 and the welding torch 12, and
an out-of-round which means a roundness of the cylinder.

The method 100 then includes calculating 110 a correction to operating parameters of the welding system 10 to align the instant arc position 38 with the optimal arc position 42. Preferably, the correction is calculated to ensure that the welding arc 16 is maintained in front of the weld pool 24, even when welding at large travelling speeds and handling a large weld pool 24.

The instant arc position 38 has an impact on the result of the welding process. For example, after the root pass, the weld 18 needs to cover the gap width at the bottom of the bevel joint 22, to go as low as the inner surfaces of the workpieces 20a and 20b and to be as flush as possible with the inner surfaces 21a, 21b of the workpieces 20a and 20b. If the weld 18 does not cover the entire gap width, the joint between the two workpieces 20a and 20b may be air and fluid permeable. If the weld 18 does not go as low as the inner surfaces of the workpieces 20a and 20b or is not as flush as possible with the inner surfaces of the workpieces 20a and 20b (i.e., creating a concave or convex finish), the flow within the workpieces will be affected and some turbulences may be created by the weld 18. Therefore, the center of the welding arc 16 needs to be at the center of the height of the weld pool 24.

In some implementations, the measured instant center of the welding arc 40 detected on the image is compared with the optimal height of the optimal arc position 42. In the example of FIG. 7, there is schematically illustrates a case where the instant center of the welding arc 40 coincides with the optical arc position 42, leading to ideal welding conditions. FIG. 7A shows an example wherein the instant center of the welding arc 40 is too low compared to the optimal arc position 42. An appropriate correction may be to reduce the travel speed to raise the center of the welding arc. In the example of FIG. 7B the instant center of the welding arc 40 is too high, and the correction may involve increasing the travel speed.

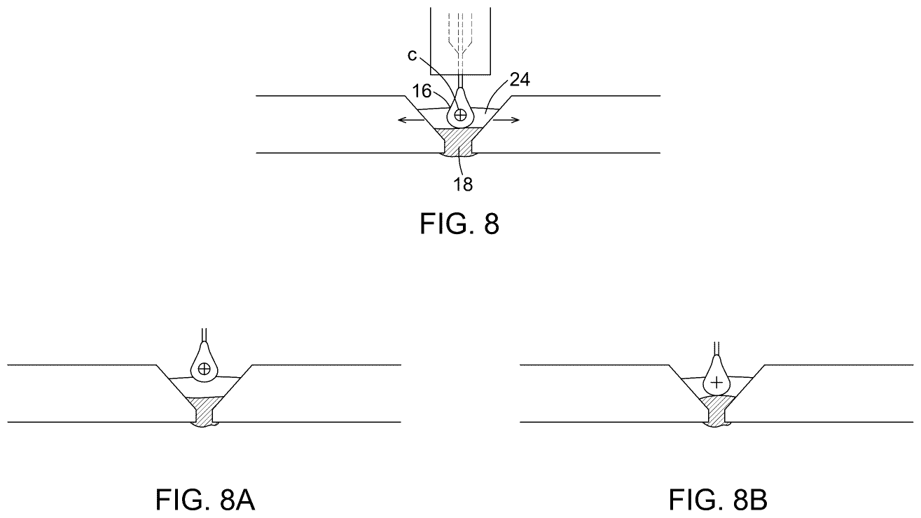

Referring to FIG. 8, another example is the position of the welding arc 16 during the filling pass. As the weld 18 is made higher in the bevel joint 22, the distance between the two workpieces 20a and 20b is larger. In these conditions, the weld pool 24 may oscillate from left to right to cover the entire length of the bevel joint 22. As mentioned earlier, the welding arc 16 needs to stay in front of the weld pool 24. If the workpiece speed is too slow (FIG. 8A), the weld pool 24 will precede too much the arc's positions and be laid in front of the arc at a much cooler temperature, i.e.

the weld pool 24 in front of the welding arc 16 has time to cool before the welding arc 16 moves forwards. In this case, the workpiece speed needs to be faster. In another case, if the arc power is too high (FIG. 8B), the welding arc will be too long and too large. Therefore, the arc power needs to be lower.

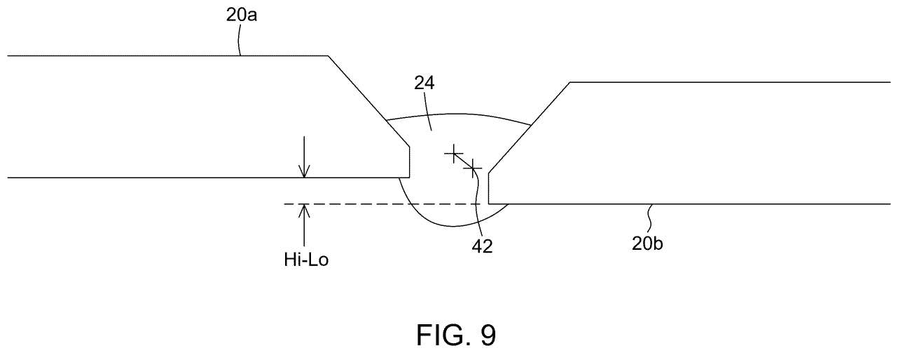

Referring to FIG. 9, there is shown an example of a situation where a hi-lo, or misalignment of the two workpieces, is measured. The optimal arc position 42 is such a case may be moved away from the center of the weld pool, towards the bottom right in the illustrated example, to compensate for the hi-lo.

In some implementations, a welding algorithm may be used to calculate the correction to compensate for irregularities such as out-of-round, off-centering, hi-lo (misalignment of the two pieces to be welded), tacks and gap changes. The correction may be embodied by a change in one of more operating parameters of the welding system such as the arc path, arc voltages, stick-out, wire speed and travel speed.

The method 100 next includes sending 112 control signals to the welding system 10 to apply the correction to the operating parameters. The control signals are the information that the welding system 10 needs in order to apply correctly the new operating parameters.

Of course, numerous additional modifications could be made to the embodiments described above without departing from the scope of protection as defined in the appended claims.

1. An automation device for automating operation of a welding system for providing a weld at a bevel joint between two metal workpieces, the welding system comprising a welding torch generating a welding arc and a welding wire being fed from the welding torch to the bevel joint to form a weld pool at the bevel joint, the automation device comprising:
a camera configured for acquiring images in real time of a welding zone comprising the bevel joint;
a processor operatively connected to the welding system and in communication with the camera to receive the images in real time, the processor configured to, for each image acquired by the camera:
a. determine an instant arc position of the welding arc in the bevel joint;
b. determine an optimal arc position of the welding arc in the bevel joint;
c. determine an error between the instant arc position and the optimal arc position;
d. calculate a correction to operating parameters of the welding system to align the instant arc position with the optimal arc position; and
e. send control signals to the welding system to apply said correction to the operating parameters thereof.

2. The automation device according to claim 1, wherein the camera comprises a CCD or a CMOS sensor.

3. The automation device according to claim 1, wherein the camera is sensitive to infrared radiation.

4. The automation device according to claim 1, wherein the camera is positioned in front of the weld pool at a right angle with a longitudinal axis of the workpieces.

5. The automation device according to claim 1, wherein the camera comprises a protective lens.

6. The automation device according to claim 1, comprising an image processing software performing the processing of each of said images.

7. The automation device according to claim 6, wherein the image processing software is configured to identify, in said images, extremities of metal workpieces at the bevel joint, the weld pool and the welding arc.

8. The automation device according to claim 6,wherein the image processing software is configured to determine a contour of the weld pool and/or a contour of the welding arc based on a shade contrast in said images.

9. The automation device according to claim 6, wherein the image processing software is configured to determine at least one of a shape of the welding arc, a position of a center of the welding arc and a length of the welding arc.

10. The automation device according to claim 6, wherein the two workpieces are separated by a gap, and the image processing software is configured to determine at least one of a width of the gap, a shape of the gap, and positions of a bottom left corner and a bottom right corner of the gap.

11. The automation device according to claim 6, wherein the image processing software is configured to determine a width of the weld pool.

12. The automation device according to claim 6, wherein the image processing software is configured to determine a distance between a bottom edge of the welding torch and a center of the welding arc.

13. The automation device according to claim 6, wherein the image processing software is configured to determine a stick-out distance of the welding wire.

14. The automation device according to claim 6, wherein the image processing software is configured to determine a relative leading front edge of the welding arc with respect to a front end of the welding pool.

15. The automation device according to claim 6, wherein the image processing software is configured to determine a mismatch in height between the two metal workpieces.

16. The automation device according to claim 6, wherein the image processing software is configured to determine:
an instant center of the welding arc;
a left corner of a bottom of the bevel joint;
a right corner of the bottom of the bevel joint;
a center of the bottom of the bevel joint;
a left corner where a left side of the bevel joint changes from going upwardly to go oblique and outwardly;
a right corner where a right side of the bevel joint changes from going upwardly to go oblique and outwardly; and
a contour of the bevel joint.

17. The automation device according to claim 1, wherein the instant arc position of the welding arc in the bevel joint determined by the processor is a position of a center of the welding arc relative to the weld pool.

18. The automation device according to claim 1, wherein the optical arc position is set in front the weld pool and aligned with a center of the weld pool.

19. The automation device according to claim 1, wherein the processor determines the optimal arc position based on a shape and dimensions of the bevel joint, the instant arc position and a position of the weld pool.

20. The automation device according to claim 1, wherein the optimal arc position is set to a next position of the welding arc along a predetermined ideal arc path.

21. The automation device according to claim 1, wherein the error between the instant arc position and the optimal arc position is set as a distance therebetween.

22. The automation device according to claim 1, wherein the operating parameters of the welding system comprise a moving speed of the workpieces.

23. The automation device according to claim 1, wherein the operating parameters of the welding system comprise a relative speed of movement between the welding torch and the workpieces.

24. The automation device according to claim 1, wherein the operating parameters of the welding system comprise an arc power of the welding arc.

25. The automation device according to claim 1, wherein the operating parameters of the welding system comprise a position of the welding torch.

26. The automation device according to claim 1, wherein the operating parameters of the welding system comprise a predetermined arc path of the welding arc.

27. The automation device according to claim 1, wherein the operating parameters of the welding system comprise a stick-out distance of the welding wire.

28. The automation device according to claim 1, wherein the operating parameters of the welding system comprise a feeding speed of welding wire.

29. The automation device according to claim 1, wherein the operating parameters of the welding system comprise:
a moving speed of the workpieces;
an arc power of the welding arc;
a position of the welding torch;
a predetermined arc path of the welding arc;
a stick-out distance of the welding wire; and
a feeding speed of welding wire.

30. The automation device according to claim 1, in combination with said welding system.

31. The combination according to claim 30, wherein the welding system comprises a welding arm configured to support and move the welding torch, the camera of the automation device being mounted on said welding arm below the welding torch.

32. The combination according to claim 30, wherein the welding system comprises one or more additional welding torches each operatively coupled to the automation device.

33. The combination according to claim 30, wherein the welding system comprises a controller operatively connected to the welding torch, the controller comprising said processor.

34. An automation method for automating operation of a welding system for providing a weld at a bevel joint between two metal workpieces, the welding system comprising a welding torch generating a welding arc and a welding wire being fed from the welding torch to the bevel joint to form a weld pool at the bevel joint, the automation method comprising:
a) acquiring, using a camera, images in real time of a welding zone comprising the bevel joint; and
via a processor operatively connected to the welding system and in communication with the camera to receive the images in real time, performing the step of:
b) processing each of the images to:
i. determine an instant arc position of the welding arc in the bevel joint;
ii. determine an error between the instant arc position and an optimal arc position; and
iii. calculate a correction to operating parameters of the welding system to align the instant arc position with the optimal arc position; and
c) sending control signals to the welding system to apply said correction to the operating parameters thereof.

35. The automation method according to claim 34, wherein the metal workpieces are pipe sections.

36. The automation method according to claim 34, comprising pre-assembling and holding together by temporary fasteners the workpieces with contiguous edges thereof forming the bevel joint.

37. The automation method according to claim 34, further comprising moving the workpieces relative to the welding torch.

38. The automation method according to claim 34, comprising performing steps a) to c) over a root welding pass.

39. The automation method according to claim 34, comprising performing steps a) to c) over a one or more filling welding passes.

40. The automation method according to claim 34, comprising performing steps a) to c) over a capping welding pass.

41. The automation method according to claim 34, comprising a start-up phase comprising performing the processing of step b) on a first set of said images without applying the corresponding correction to the operating parameters.
